(19) United States
(12) Patent Application Publication
(10) Pub. No.: US 2023/0237494 A1
(43) Pub. Date: Jul. 27, 2023

(54) SYSTEMS AND METHODS FOR AUTOMATICALLY CREATING MACHINE LEARNED FRAUD DETECTION MODELS

(71) Applicant: Actimize Ltd., Ra'anana (IL)

(72) Inventors: Amir SHACHAR, Haifa (IL); Michal Einhorn-Cohen, Rosh Haayin (IL)

(73) Assignee: Actimize Ltd., Ra'anana (IL)

(21) Appl. No.: 17/585,744

(22) Filed: Jan. 27, 2022

(51) Int. Cl. G06Q 20/40; G06K 9/62; G06N 20/20

(52) U.S. Cl. CPC G06Q 20/4016; G06K 9/6257; G06N 20/20

(57) ABSTRACT

A system and method is provided for automatically creating machine learned fraud detection models. Data received from a plurality of devices can be used to train a model for each of the plurality of entities. Each of the models can be trained using recursive model stacking and each model can output a corresponding score. A second model can be trained for each of the plurality of entities based on the first model and a corresponding output score of the first model. The second model can also be trained using recursive model stacking.

### FIELD OF THE INVENTION

The invention relates to detecting anomalous transaction, such as money laundering, fraud, or non-compliant transactions, using an artificial intelligence system. The invention more specifically relates to a system and method for automatically creating machine learned fraud detection models to identify the anomalous transactions data sets.

### BACKGROUND OF THE INVENTION

Anomaly detection in transaction data sets can be a difficult task for modern intelligent systems. Anomalies in transaction data sets can represent money laundering, fraud, and/or transactions that do not comply with rules, laws, and/or regulations. However, for a particular entity, such as a bank or other financial entity, data sets for anomalies often contain little to no fraud. These commercial financial entities generally encounter lower rates of fraud or anomalous transaction than in other transaction categories, such as retail transactions. The anomalous transactions in these commercial financial data sets may be important to ensure that the entity is compliant with laws and regulations required for the entity, as well as to minimize risk and loss by the entity.

Anomalous transactions can be detected with machine learned models. The machine learned models are typically trained with transaction data sets from a particular entity. Prior to training the machine learned models with entity specific transaction data, one or more generic models can be used. However, the generic models can produce high rates of errors. Training the machine learned models with transaction data that is specific to a particular entity can take a long period of time (e.g., nine months). Therefore, it can be desirable to create fraud detection models that have accuracy without requiring a long period of training time.

### SUMMARY OF THE INVENTION

One advantage of the invention can include models that provide a high level of accuracy without a long period of training time. Another advantage of the invention can include more general models that can perform better on data that has not been previously seen.

In one aspect, the invention involves a computerized-method for automatically creating machine learned fraud detection models. The method can involve receiving, by a computing device, data from a plurality of entities. The method can also involve training, by the computing device, a model for each of the plurality of entities based on the received data, wherein each model is trained using recursive model stacking and each model outputs a corresponding score. The method can also involve training, by the computing device, a second model for each of the plurality of entities based on the corresponding output score of each model, wherein the each model is trained using recursive model stacking and wherein one score is output for all models.

In some embodiments, the method also involves training n models for each of the plurality of entities based on the n−1 score output for all models and wherein each of the n models for each of the plurality of entities is trained using recursive model stacking.

In some embodiments, the one score is based on an aggregation statistic of a score output from all of the second models for each of the plurality of entities. In some embodiments, the aggregation statistic is an average. In some embodiments, training of the model, the second model and the n models is performed in a pipeline.

In some embodiments, the recursive model stacking is recursive federated learning.

In another aspect, the invention includes a system for automatically creating machine learned fraud detection models. The system can include at least one processor configured to receive at a server data from a plurality of entities. The at least one processor can also be configured to train at the server a model for each of the plurality of entities based on the received data, wherein each model is trained using recursive model stacking and each model outputs a corresponding score. The at least one process can also be configured to train at the server a second model for each of the plurality of entities based on the corresponding output score of each model, wherein the each model is trained using recursive model stacking and wherein one score is output for all models.

In some embodiments, the at least one processor is further configured to train n models for each of the plurality of entities based on the n−1 score output for all models and wherein each of the n models for each of the plurality of entities is trained using recursive model stacking.

In some embodiments, the one score is based on an aggregation statistic of a score output from all of the second models for each of the plurality of entities.

In some embodiments, the aggregation statistic is an average. In some embodiments, training of the model, the second model and the n models is performed in a pipeline. In some embodiments, the recursive model stacking is recursive federated learning.

In another aspect, the invention includes a non-transitory computer program product comprising instruction which, when the program is executed cause the computer to receive at a server data from a plurality of entities. The computer program product can also include instructions which, when the program is executed cause the computer to train at the server a model for each of the plurality of entities based on the received data, wherein each model is trained using recursive model stacking and each model outputs a corresponding score. The computer program product can also include instructions which, when the program is executed cause the computer to train at the server a second model for each of the plurality of entities based on the corresponding output score of each model, wherein the each model is trained using recursive model stacking and wherein one score is output for all models.

In some embodiments, the computer program product can also include instructions which, when the program is executed cause the computer to train n models for each of the plurality of entities based on the n−1 score output for all models and wherein each of the n models for each of the plurality of entities is trained using recursive model stacking.

In some embodiments, the one score is based on an aggregation statistic of a score output from all of the second models for each of the plurality of entities. In some embodiments, the aggregation statistic is an average. In some embodiments, training of the model, the second model and the n models is performed in a pipeline. In some embodiments, the recursive model stacking is recursive federated learning.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of a system for fraud detection, according to some embodiments of the invention.

FIG. 2 is a method for automatically creating machine learned fraud detection, according to some embodiments of the invention.

FIG. 3 is a diagram illustrating the method for automatically creating machine learned fraud detection, according to some embodiments of the invention.

FIG. 4 are graphs showing a detection rate over time, according to some embodiments of the invention

FIG. 5 is a block diagram of a computing device which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

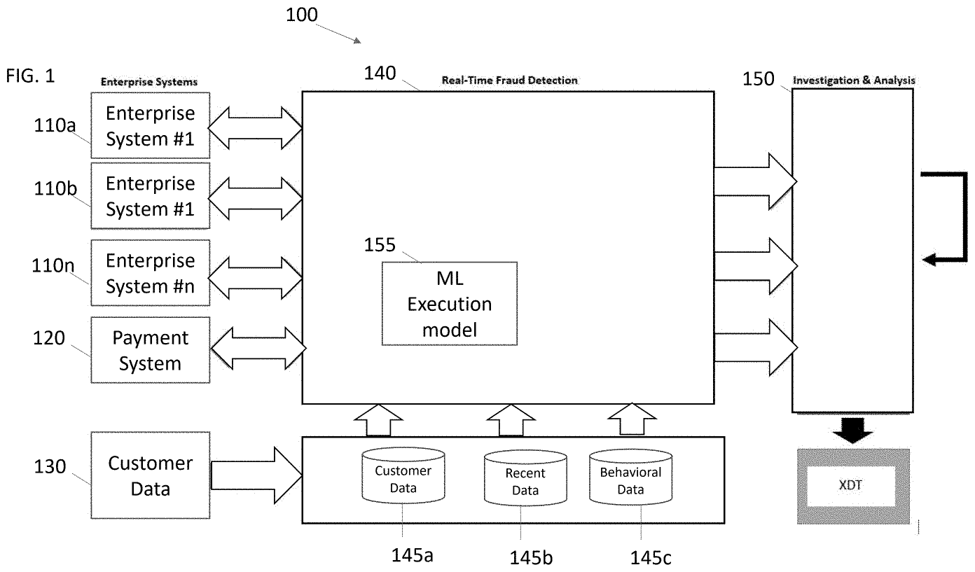

FIG. 1 is a block diagram of a system 100 for fraud detection, according to some embodiments of the invention. The system can include multiple enterprise systems, 110a through 110n, a payment system 120, customer data 130, real-time fraud detection 140, a plurality of databases, 145a, 145n, 145c, and an analysis module 150.

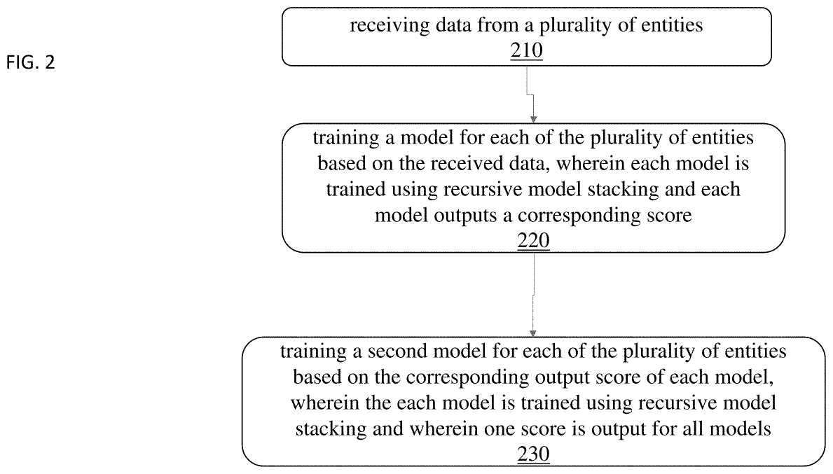

The real-time fraud detection 140 can include machine learning execution module 155. The machine learning execution model 155 can include steps to train a model for the multiple enterprise systems 110, payments systems 120, and/or customer data 130 using a recursive model stacking as described below in FIG. 2.

FIG. 2 is a method for automatically creating machine learned fraud detection, according to some embodiments of the invention.

The method involves receiving data from a plurality of entities (Step 210). The data can include transaction data. The plurality of entities can include different financial entities. For example, banks, trading houses, hedge funds, credit unions, or any other entity that may handle financial records, process transactions, and otherwise provide financial products to others.

The method involves training a model for each of the plurality of entities based on the received data, wherein each model is trained using recursive model stacking and each model outputs a corresponding score (Step 220). In some embodiments, training a model for each of the plurality of entities based on the received model

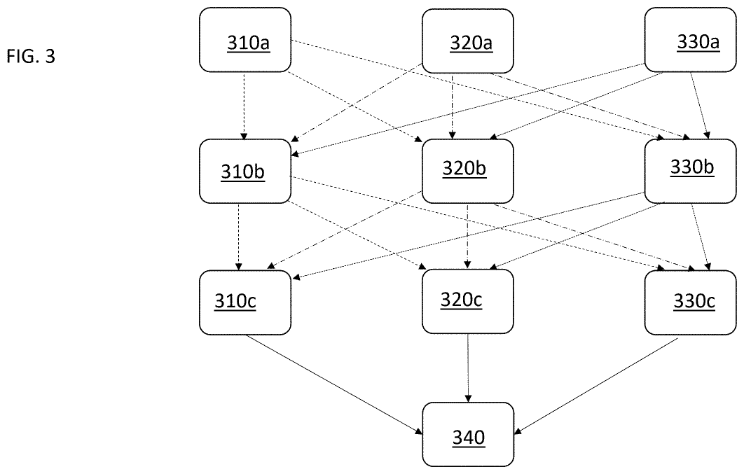

For example, turning to FIG. 3, FIG. 3 is a diagram illustrating the method for automatically creating machine learned fraud detection, according to some embodiments of the invention. In FIG. 3, assume a plurality of entities of a first entity, a second entity and a third entity. In this example, the first entity's data is used to train a first entity model 310a, the second entity's data is used to create a second entity model 320a, and the third entity's data is used to create a third entity model 330a. The first entity model 310a, the second entity model 320a, and the third entity model 330a, are each input to a recursive model stacking algorithm to train a revised first entity model 310b, a revised second entity model 320b, and a revised third entity model 330b. Each of the revised first entity model 310b, a revised second entity model 320b, and a revised third entity model 330b can output a corresponding score.

The recursive model stacking algorithm can be federated transfer learning training, as described, for example, in co-pending application Ser. No. 16/866,139 filed on May 4, 2020, the entire contents of which are incorporated herein by reference in its entirety.

Turning back to FIG. 2, the method involves training a second model for each of the plurality of entities based on the corresponding output score of each model, wherein each model is trained using recursive model stacking and wherein one score is output for all models (Step 230).

Turning back to FIG. 3, continuing with the example above, the corresponding output score of the revised first entity model 310b, the revised second entity model 320b, and the revised third entity model 330b can be used to train via a recursive model stacking a second model for each of the plurality of entities, resulting in a second first entity model 310c, a second second entity model 320c, and the second third entity model 330c. The second first entity model 310c, a second second entity model 320c, and the second third entity model 330c can be used to create one final model 340 that outputs one score for all the models.

The recursive model stacking can be federated transfer learning training as described above.

In this manner, bias with respect to each of the entities particular data can be substantially eliminated.

In various embodiments, n iterations in the recursive model stacking, where n is an integer. The number of n iterations can be based on a size of the data, a desired accuracy. In various embodiments, n is 3, 4, 5, 6, 7, or 8.

In various embodiments, each iteration can further contributes to entity independence of a model.

In some embodiments, training a first model for each of the plurality of entities based on the received data involves training models M_{1,1}, M_{2,1}, . . . M_{N,1} for each of the source datasets S_{1,1}, S_{2,1}, . . . S_{N,1}, respectively, using Sklearn pipeline that stores all data transformation and modeling a pipeline object. In some embodiments, these steps can be implemented with the following code:

```
Splitting the entire test set to 3:
Train set − to fit transfer learning models
validation_fl − to fit ML model on transfer models score
Validation_rfl − to re-fit ML model on federation learning scores (that was calculated based on
validation_fl models)
df_total = DataAccessLyaer.read.parquet(f’user_name/thick/{project_id_v1}/df_total.parquet’)
  • Train
selected_pct_train = round(df_total.shape[0]*0.6) # e.g., 60% for train
df_train = df_total[0:selected_pct_train]
print(df_train.shape)
print(df_transactoinnormalizedatetime.min( ))
print(df_ transactoinnormalizedatetime.max( ))
print(df_train.fraud.value.counts( ))
y_train = df_train.fraud
df_train.drop([fraud’], axis = 1, inplace = True)
df_train.shape
  • Validation_fl
selected_pct_val = round(df_total.shape[0]*0.2 #e.g.: 20% for validation
df.shape
project_id_v1
model1, mode12, model3 = create_models(df.copy( ), label.copy( ), project_id_v1, estimator)
#compress files
import gzip
source_bank_name = ‘usb’ #e.g., usb
# create folder for transferred models
New folder = f’transfer_learning/{source_bank_name]_models’
os.makedirs(new_folder)
#store the object
f1 = gzip.open(f’{new_folder}/{source_bank_name}_my_model1.pklz’, ’wb’)
pickle.dumb(model1,f1)
f1.close( )
f2 = gzip.open(f’{new_folder}/{source_bank_name}_my_model2.pklz’, ’wb’)
pickle.dumb(model2,f2)
f2.close( )
f3 = gzip.open(f’{new_folder}/{source_bank_name}_my_model3.pklz’, ’wb’)
pickle.dumb(model3,f3)
f3.close( )
```

Storing the models in a pipeline object can include zipping them, for example, with gzip technology.

In some embodiments, training a second model for each of the plurality of entities includes for each 1<r<R, where R is a number of recursion levels, then for each 1<n<N, where N is the number of models (e.g., saved in the zipped models), transfer the models that are stored (e.g., zipped models) M_{1,r}, M_{n-1,r}, M_{n+1,r}, . . . , M_{N,r}; applying the models, M_{1,r}, . . . M_{N,r} to the dataset Sn,r+1 to generate N scores, S1,r for each record of Sn, R+1, using transform method of the Sklearn pipeline; train a model M_{n,r+1} whose input features are the calculated scores S1,r, . . . sN,r and whose labels are these of the dataset Sn,r+1, using fit method of Sklearn pipeline; and/or zip the generated model object, for example, using gzip. In some embodiments, these steps can be implemented with the following code:

```
def get_transfer_learning_scores_df(tenants_list: list):
  tl_scores_df = pd.DataFrame( )
  for tenant in tenants_list:
  tl_scores_df[tenant]=pickle.load(open(f’predictoin_{tenant]_val_fl.pickle’))
  return tl_scores_df
def get_fl_model(tenants_list: list, df_labels:list, source_bank_name:str):
‘’’this function fit and saves model based on val_fl transferred models ’predictions”’
Scores_df = get_transfer_learning_scores_df(tenants_list)
mdl = XGBClassifier (random_state = 11850)
mdl = scores_df, train labels
new_folder = f’recursive_fl/val_fl/{source_bank_name}_model’
os.makedirs(new_folder)
pickle_data(mdl, new_folder)
print(f’model was fit and saved to: [new_folder].pickle’)
return
    • Set Parameters
tenants_list = tenants_list
df_labels = DataAcessLayer.read_parquet(f’user_name/thick/{project_id_v1}/y_val_fl.p
source_bank_name = source_bank_name
get_fl_model(tenants_list, df_labels, tenant)
def get_rfl_model(tenants_list: list, df_labels: list, source_bank_name:str):
  ‘’’this function fit and saves model based on val_fl tranferred models’ predictions
  ‘’’
  fl_scores_df = pd.DataFrame( )
  for model in tenants_list:
        model_path = f’weighted_models/xgb_weighted_model_(model)
        fl_scores[model] = calc_fl_score(tenants_list, model_path)
scores={ }
mdl = XGBClassifier(random_state = 11850)
mdl.fit(fl_scores, df_labels)
new_folder = f’recursive_fl/val_rfl/{source _bank_name}_model’
os.makedirs(new_folder)
print(f’model was fit and saved to: {new_folder).pickle’)
return
    • Set Parameters
tenants_list = tenants_list
df_labels =
DataAccessLayer.read_parquet(f’user_name/thick/{project_id_v1}/y_val_rfl.parquet’)
source_bank_name = source_bank_name
get_rfl_model(tenants_list, df_labels, source_bank_name)
```

In some embodiments, the models can be applied to target data. The models M1,R, . . . MN,R can be applied to the target data T to generate N scores S1,R, . . . sN,R for each record of T, using, for example, a transform method of Sklearn pipeline object. A statistical aggregation tool (e.g., median) can be applied using python aggregations functions to the scores, s1,R, . . . sN,R and use the aggregation as the final score of the dataset T. In some embodiments, these steps can be implemented with the following code:

```
Auxiliary functions (Pipeline_classes included)
import sys
sys.path.append(‘fruad_ai_research/00TB/Templates/Recursive Transfer FL’)
from auxiliar_functions import *
Apply transfer learning models on test set
  • Setting parameter
ba = ‘mp2p’ #base activity
m_type = ‘thick’ # type of model
tenants_list = [‘usb’, ‘jpmc’, ‘pnc’] #list of all source banks
  • Running transfer learning models on target banks’s test set
for model in tenants_list:
print(f’now applying {model} model’)
model1 = pickle.load(gzip.open(f’(model)_models/{model}_{ba}_{m_type}_model1.pklz’, ’rb’))
model2 = pickle.load(gzip.open(f’(model)_models/{model}_{ba}_{m_type}_model2.pklz’, ’rb’))
model3 = pickle.load(gzip.open(f’(model)_models/{model}_{ba}_{m_type}_model3.pklz’, ’rb’))
df_test_DatAccessLayer.read_parquet(f’user_name/thick/{project_id_v1}/preprocessed_test.pa
rquest’
model1_name=f’user_name/transfer
learning/{m_type}/model}/{project_id_v1}/preprocessed_test.parquet’
model2_name=f’user_name/transfer learning/{m_type}/model}/{project_id_v1}/X_test.parquet’
model3_name=f’{mode}_t1_test’
y_pred=apply+models(df_test.copy( ),model1,model1_name,model2,model2_name,models3,model
3_name)
```

### Model Evaluation

Model evaluation API in order to compare performance of mean recursive FL score to transfer-learning scores separately
import sys
sysm.path.append(‘fraud_ai_research/model_template_model_evaluation_api’) from cross_evaluation import*

### Calculate Mean Recursive Federation Learning Scores

Calculate new scored based on mean of the transfer learning scores combination based on ML models that was learned on different tenants validation set

```
Input:
    • Transferred models tenants list
    • rft models folder’s path
Output:
    • mean recursive FL score
def get_mean_rfl_scores(tenants_list: list, rfl_models_folder: str):
  rfl_scores ={ }
  for tenant in tenants_list:
        rfl_scores{tenant} ={ }
        model_path = f’/home/ec2-user/SageMaer/{rfl_models_foler}/{tenant}_model’
        rfl_scores.update({tenant:calc_rfl_scores(tenants_list,model_path)})
  df = pd.DateFrame.from_dict(rfl_scores)
  means_rfl_score = df.mean(axis = 1)
  return mean rfl_score
    • Setting parameters
  Note: make sure to place all rfl models in separate folder and set folder’s name under
  rfl_models_folder parameter
tenants_list = [‘usb’, ‘jpmc’,’pnc’]
rfl_models_folder = ‘rfl_models’
    • Apply get_mean_recursive_fl_scores function
Mean_rfl_pred = get_mean_rfl_scores (tenants_list, rfl_models,folder)
```

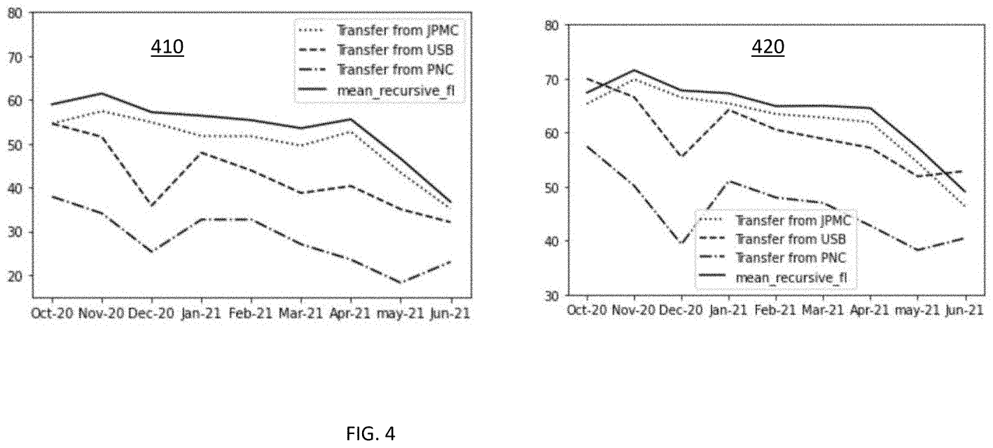

FIG. 4 are graphs 410 and 420 showing a detection rate over time, according to some embodiments of the invention. As shown in FIG. 4, the detection is depicted along a y axis over and time, 9 months in this example, is depicted along x axis, for an ˜1% alert rate on an example institution data. The dotted lines represent the detection rate of the different transferred models from example consortium data and the solid line represents the detection rate for the mean recursive federated learning model. Graph A represents the models' performance when the bank has less then 3 months accumulated data and graph B represents the models' performance after 3 months of accumulated data. To quantify the difference in performance a percent change of mean recursive FL models can be calculated from the best transferred model (JPMC) along the months and a median percent change was taken. For graph A 7% median percent change occurred, and for graph B a 3% median percent change occurred.

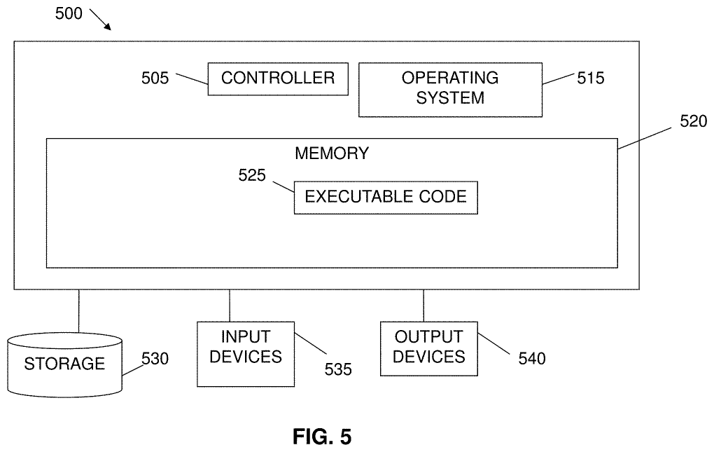

FIG. 5 shows a block diagram of a computing device 500 which can be used with embodiments of the invention. Computing device 500 can include a controller or processor 505 that can be or include, for example, one or more central processing unit processor(s) (CPU), one or more Graphics Processing Unit(s) (GPU or GPGPU), a chip or any suitable computing or computational device, an operating system 515, a memory 520, a storage 530, input devices 535 and output devices 540.

Operating system 515 can be or can include any code segment designed and/or configured to perform tasks involving coordination, scheduling, arbitration, supervising, controlling or otherwise managing operation of computing device 500, for example, scheduling execution of programs. Memory 450 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 520 can be or can include a plurality of, possibly different memory units. Memory 520 can store for example, instructions to carry out a method (e.g. code 525), and/or data such as user responses, interruptions, etc.

Executable code 525 can be any executable code, e.g., an application, a program, a process, task or script. Executable code 525 can be executed by controller 505 possibly under control of operating system 515. For example, executable code 525 can when executed cause masking of personally identifiable information (PII), according to embodiments of the invention. In some embodiments, more than one computing device 500 or components of device 500 can be used for multiple functions described herein. For the various modules and functions described herein, one or more computing devices 500 or components of computing device 500 can be used. Devices that include components similar or different to those included in computing device 500 can be used, and can be connected to a network and used as a system. One or more processor(s) 505 can be configured to carry out embodiments of the invention by for example executing software or code. Storage 530 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 530 and can be loaded from storage 530 into a memory 520 where it can be processed by controller 505. In some embodiments, some of the components shown in FIG. 5 can be omitted.

Input devices 535 can be or can include for example a mouse, a keyboard, a touch screen or pad or any suitable input device. It will be recognized that any suitable number of input devices can be operatively connected to computing device 500 as shown by block 535. Output devices 540 can include one or more displays, speakers and/or any other suitable output devices. It will be recognized that any suitable number of output devices can be operatively connected to computing device 500 as shown by block 540. Any applicable input/output (I/O) devices can be connected to computing device 500, for example, a wired or wireless network interface card (NIC), a modem, printer or facsimile machine, a universal serial bus (USB) device or external hard drive can be included in input devices 535 and/or output devices 540.

Embodiments of the invention can include one or more article(s) (e.g. memory 520 or storage 530) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A computerized-method for automatically creating machine learned fraud detection models, the method comprising:
receiving, by a computing device, data from a plurality of entities;
training, by the computing device, a model for each of the plurality of entities based on the received data, wherein each model is trained using recursive model stacking and each model outputs a corresponding score; and
training, by the computing device, a second model for each of the plurality of entities based on the corresponding output score of each model, wherein the each model is trained using recursive model stacking and wherein one score is output for all models.

2. The computerized-method of claim 1 further comprising training n models for each of the plurality of entities based on the n−1 score output for all models and wherein each of the n models for each of the plurality of entities is trained using recursive model stacking.

3. The computerized-method of claim 1 wherein the one score is based on an aggregation statistic of a score output from all of the second models for each of the plurality of entities.

4. The computerized-method of claim 3 wherein the aggregation statistic is an average.

5. The computerized-method of claim 3 wherein training of the model, the second model and the n models is performed in a pipeline.

6. The computerized-method of claim 1 wherein the recursive model stacking is recursive federated learning.

7. A system for automatically creating machine learned fraud detection models, the system comprising:
at least one processor configured to:
receive at a server data from a plurality of entities;
train at the server a model for each of the plurality of entities based on the received data, wherein each model is trained using recursive model stacking and each model outputs a corresponding score; and
train at the server a second model for each of the plurality of entities based on the corresponding output score of each model, wherein the each model is trained using recursive model stacking and wherein one score is output for all models.

8. The system of claim 7 wherein the at least one processor is further configured to train n models for each of the plurality of entities based on the n−1 score output for all models and wherein each of the n models for each of the plurality of entities is trained using recursive model stacking.

9. The system of claim 7 wherein the one score is based on an aggregation statistic of a score output from all of the second models for each of the plurality of entities.

10. The system of claim 7 wherein the aggregation statistic is an average.

11. The system of claim 7 wherein training of the model, the second model and the n models is performed in a pipeline.

12. The system of claim 7 wherein the recursive model stacking is recursive federated learning.

13. A non-transitory computer program product comprising instruction which, when the program is executed cause the computer to:
receive at a server data from a plurality of entities;
train at the server a model for each of the plurality of entities based on the received data, wherein each model is trained using recursive model stacking and each model outputs a corresponding score; and
train at the server a second model for each of the plurality of entities based on the corresponding output score of each model, wherein the each model is trained using recursive model stacking and wherein one score is output for all models.

14. The non-transitory computer program product of claim 13 further comprising training n models for each of the plurality of entities based on the n−1 score output for all models and wherein each of the n models for each of the plurality of entities is trained using recursive model stacking.

15. The non-transitory computer program product of claim 13 wherein the one score is based on an aggregation statistic of a score output from all of the second models for each of the plurality of entities.

16. The non-transitory computer program product of claim 13 wherein the aggregation statistic is an average.

17. The non-transitory computer program product of claim 13 wherein training of the model, the second model and the n models is performed in a pipeline.

18. The non-transitory computer program product of claim 13 wherein the recursive model stacking is recursive federated learning.
